(19) United States
(12) Patent Application Publication
(10) Pub. No.: US 2011/0018626 A1
(43) Pub. Date: Jan. 27, 2011

(54) QUADRATURE AMPLITUDE DEMODULATOR AND DEMODULATION METHOD

(75) Inventor: Shoji Kojima, Tokyo (JP)

Correspondence Address: LADAS & PARRY, 5670 WILSHIRE BOULEVARD, SUITE 2100, LOS ANGELES, CA, 90036-5679, US

(73) Assignee: ADVANTEST CORPORATION, Tokyo (JP)

(21) Appl. No.: 12/670,111

(22) PCT Filed: Oct. 24, 2008
(86) PCT No.: PCT/JP2008/003036

§ 371 Date: Jan. 21, 2010

(51) Int. Cl. H04L 27/22; G06F 19/00

(52) U.S. Cl. 329/306; 702/124

(57) ABSTRACT

A quadrature amplitude demodulator demodulates a modulated signal on which quadrature amplitude modulation is performed. Oscillators generate an in-phase carrier signal having a rectangular wave, a trapezoidal wave or a waveform similar to these, and a quadrature carrier signal, the phase of which is shifted by ¼ cycle relative to the in-phase signal. First and second mixers respectively perform mixing of the modulated signal with the in-phase signal and the quadrature carrier signal. First and second integrators respectively integrate output signals of the first and the second mixers, for a predetermined period in accordance with the cycle of the in-phase carrier signal and the quadrature carrier signal. First and second A/D converters respectively convert outputs of the first and the second integrators into digital values.

### CROSS-REFERENCE TO RELATED APPLICATIONS

This application is the U.S. National Stage of International Patent Application No. PCT/JP2008/003036, filed on Oct. 24, 2008, the disclosure of which is incorporated herein by reference.

### BACKGROUND OF THE INVENTION

1. Field of the Invention

The present invention relates to a technique for transmitting digital data.

2. Description of the Related Art

In a digital cable communication system, a binary transmission using the Time Division Multiplex (TDM) method has been conventionally the mainstream in which a large capacity transmission has been realized by a parallel transmission or a high-speed transmission. When the parallel transmission faces a physical limit, a serial transmission, i.e., a high-speed transmission at a data rate of several to more than 10 Gbps by using a high-speed interface (I/F) circuit is performed. However, there is also a limit to the increase in the speed of the data rate, causing a problem of high-frequency loss of a transmission line and deterioration of BER (Bit Error Rate) by reflection.

On the other hand, in a digital radio communication system, multi-bit information is transmitted/received by being embedded in a carrier signal. That is, the data rate is not directly restricted by a carrier frequency. For example, in the QAM (Quadrature Amplitude Modulation) transmission method, most basic quadrature modulation/demodulation method, a 4-level transmission can be realized by a single channel. In 64-QAM, a 64-level transmission can be realized by one carrier signal. That is, a transmission capacity can be improved by such a multi-level modulation method without increasing the carrier frequency.

Such a modulation/demodulation method can be used in a cable communication system without being limited to a radio communication system, the use of which has already been started as PAM (Pulse Amplitude Modulation) system, QPSK (Quadrature Phase Shift Keying) system or DQPSK (Differential QPSK) system. In particular, in an optical communication field, it is important how much information can be embedded in a single optical fiber in terms of costs, and hence, a technical trend is shifting from the binary TDM to a transmission using these digital modulation methods. There is a possibility that, in the near future, these digital multi-level modulation/demodulation methods may be used in cable interfaces between devices including a memory and a SoC (System on a Chip).
[Patent Document 1] U.S. Pat. No. 5,652,552

Because a conventional quadrature amplitude modulator/demodulator is required to be structured by using a high-speed device, design of the modulator is not easy, or a high-frequency bipolar process or Bi-CMOS process is needed. Therefore, there is a problem that production cost of the device becomes high.

### SUMMARY OF THE INVENTION

The present invention has been made in view of these circumstances, and one of the illustrative purposes thereof is to provide a quadrature amplitude demodulator that can readily implement data.

An embodiment of the present invention relates to a quadrature amplitude demodulator that demodulates a modulated signal on which quadrature amplitude modulation is performed. The quadrature amplitude demodulator comprises: an oscillator configured to generate an in-phase carrier signal having a rectangular wave, a trapezoidal wave or a waveform similar to these, and a quadrature carrier signal, the phase of which is shifted by ¼ cycle relative to the in-phase carrier signal; first and second mixers configured to respectively perform mixing of the modulated signal with the in-phase carrier signal and the quadrature carrier signal; first and second integrators configured to respectively integrate output signals of the first and the second mixers for a predetermined period in accordance with the cycle of the in-phase carrier signal and the quadrature carrier signal; and first and second A/D converters configured to respectively convert outputs of the first and the second integrators into digital values.

The aforementioned “a rectangular wave, a trapezoidal wave or a waveform similar to these” can also be considered to be a signal taking constant levels at the peak and the bottom of its cycle. According to the embodiment, a baseband component of the signal on which the mixing (down-conversion) is performed can be extracted by integrating the signal using a rectangular wave or a trapezoidal wave as a carrier signal for demodulation (also referred to as an RF signal) instead of a sine wave (cosine wave), for a symbol period or a carrier cycle. According to the embodiment, there is an advantage that a low-pass filter, necessary in a conventional demodulator, is not needed.

The quadrature amplitude demodulator according to an embodiment may further comprise first and second sample-hold circuits configured to respectively sample and hold the output signals of the first and the second integrators at every boundary between symbols that are adjacent to each other in terms of time. The first and the second A/D converters may respectively convert output signals of the first and the second sample-hold circuits into digital values.

The modulated signal, the in-phase carrier signal and the quadrature carrier signal may be respectively differential signals, and the first and the second mixers may be respectively Gilbert Cell mixers configured to perform the mixing of the modulated signal with the corresponding carrier signals. This embodiment is suitable for the CMOS (Complementary Metal Oxide Semiconductor) process.

Each of the first and the second integrators may respectively include: a first capacitor configured to be provided between a line through which each of the output signals of the first and the second mixers is propagated, and a fixed voltage terminal; and a first switch configured to initialize an electric charge of the first capacitor at every boundary between the symbols adjacent to each other in terms of time. This embodiment is suitable for the CMOS (Complementary Metal Oxide Semiconductor) process.

The respective output signals of the first and the second mixers maybe differential signals. Each of a pair of the first integrator and the first sample-hold circuit and a pair of the second integrator and the second sample-hold circuit, may include; a first input terminal configured to receive a first polarity signal of differential output signals of the corresponding mixer; a second input terminal configured to receive a second polarity signal of the differential output signals of the corresponding mixer; an output terminal; a second capacitor; a third capacitor; a second switch configured to include first, second and third terminals, the first terminal of which is connected to the first input terminal, and the second terminal of which receives a predetermined fixed voltage, and the third terminal of which is connected to one end of the second capacitor; a third switch configured to include first, second and third terminals, the second terminal of which is connected to the first input terminal, and the first terminal of which receives a predetermined fixed voltage, and the third terminal of which is connected to one end of the third capacitor; a fourth switch configured to include first, second and third terminals, the second terminal of which is connected to the output terminal, and the first terminal of which is connected to the second input terminal, and the third terminal of which is connected to the other end of the second capacitor; a fifth switch configured to include first, second and third terminals, the first terminal of which is connected to the output terminal, and the second terminal of which is connected to the second input terminal, and the third terminal of which is connected to the other end of the third capacitors; and a sixth switch, one end of which is connected to the output terminal, and the other end of which is applied with a fixed voltage. The second through the fifth switches may respectively place alternately a first state where the first terminal and the third terminal conduct electricity to each other, and a second state where the second terminal and the third terminal conduct electricity to each other, at every boundary between the symbols that are adjacent to each other in terms of time; and the sixth switch may be turned on for a predetermined period prior to the time when the symbols are switched. In this case, a circuit area can be small.

Each of the first and the second A/D converters may include: a plurality of comparators configured to respectively compare output signals of the corresponding integrators with threshold voltages set for the respective integrators; an encoder configured to receive output signals of the plurality of comparators to encode the output signals; and a latch circuit configured to latch the outputs of the plurality of comparators or an output of the encoder, or both of the two. In this case, the sample-hold circuit is not required to be mounted in the preceding stages of the A/D converter, allowing a circuit area to be reduced.

Each of the first and the second mixers may include: a first input terminal configured to receive the first polarity signal of the differential modulated signals; a second input terminal configured to receive the second polarity signal of the differential modulated signals; first and second gates configured to be provided in series between the first and the second input terminals; third and fourth gates configured to be provided in series between the first and the second input terminals, and provided in parallel with a pathway formed by the first and the second gates; and a differential amplifier configured to differentially amplify an electric potential at the connection point of the first and the second gates, and that at the connection point of the third and the fourth gates. A pair of the first and the third gates and a pair of the second and the fourth gates, may complementarily repeat on/off in accordance with the corresponding carrier signals. This structure is also suitable for the CMOS process.

When the frequency of the in-phase carrier signal and the quadrature carrier signal is equal to a symbol rate of the modulated signal, the first and the second integrators may respectively integrate the output signals of the first and the second mixers, for one cycle of the carrier signal.

When the frequency of the in-phase carrier signal and the quadrature carrier signal is n times larger than the symbol rate of the modulated signal, the first and the second integrators may respectively integrate the output signals of the first and the second mixers, for n cycles of the carrier signal.

Another embodiment of the present invention relates to a test apparatus for testing a quadrature amplitude modulated signal outputted from a device under test. The apparatus comprises: the quadrature amplitude demodulator according to any one of the embodiments stated above configured to demodulate the signal from the device under test; and a decision unit configured to compare data demodulated by the quadrature amplitude demodulator with an expected value.

Yet another embodiment of the present invention relates to a semiconductor apparatus. The apparatus comprises the quadrature amplitude demodulator according to any one of the embodiments stated above.

Yet another embodiment of the present invention relates to a method for demodulating a modulated signal on which quadrature amplitude modulation is performed. The method comprises the following processing:

1. generating an in-phase carrier signal having a rectangular wave, a trapezoidal wave or a waveform similar to these, and a quadrature carrier signal, the phase of which is shifted by ¼ cycle relative to the in-phase carrier signal;

2. performing mixing of the modulated signal with the in-phase carrier signal and the quadrature carrier signal, respectively;

3. integrating an in-phase component and a quadrature component that are obtained by the mixing, for a predetermined period in accordance with the cycle of the in-phase carrier signal and the quadrature carrier signal, respectively; and

4. converting the in-phase component and the quadrature component that are obtained by the integrating into digital values, respectively.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram illustrating the structure of a transmission system using a quadrature amplitude demodulator according to an embodiment;

FIG. 2 is a time chart illustrating operation of the quadrature amplitude demodulator in FIG. 1;

FIG. 3 is another time chart illustrating operation of the quadrature amplitude demodulator in FIG. 1;

FIG. 4 is yet another time chart illustrating operation of the quadrature amplitude demodulator in FIG. 1;

FIG. 5 is a circuit diagram illustrating specific examples of the structures of a mixer and an integrator;

FIG. 6 is a time chart illustrating a reset signal RST and a sample-hold signal S&H in FIG. 5;

FIG. 7 is a circuit diagram illustrating specific examples of the structures of the integrator and the sample-hold circuit;

FIG. 8 is a time chart illustrating operations of the integrator and the sample-hold circuit in FIG. 7;

FIG. 9 is a circuit diagram illustrating a specific example of the structure of an A/D converter;

FIG. 10 is a time chart illustrating operation of the A/D converter in FIG. 9;

FIG. 11 is a circuit diagram illustrating another example of the structure of the mixer; and

FIG. 12 is a block diagram illustrating the structure of a test apparatus in which the quadrature amplitude demodulator according to an embodiment is mounted.

### Reference Numerals

### DETAILED DESCRIPTION OF THE INVENTION

The present invention will be described below with reference to the drawings based on the preferred embodiments. The same or equivalent constituting elements, members and processing illustrated in each drawing shall be denoted by the same reference numerals, and the duplicative explanations will be omitted appropriately. The embodiments do not intend to limit the scope of the present invention, but exemplify the invention. All of the features and the combinations thereof described in the embodiments are not necessarily essential to the invention.

Herein, “the state where a member A is connected to a member B” includes not only the state where the member A is physically and directly connected to the member B but also the state where the member A is indirectly connected to the member B via another member that does not affect electrically the connection state between them. Likewise, “the state where a member C is provided between a member A and a member B” includes not only the state where the member A and the member C, or the member B and the member C, are connected directly, but also the state where they are connected indirectly via another member that does not affect electrically the connection state between them.

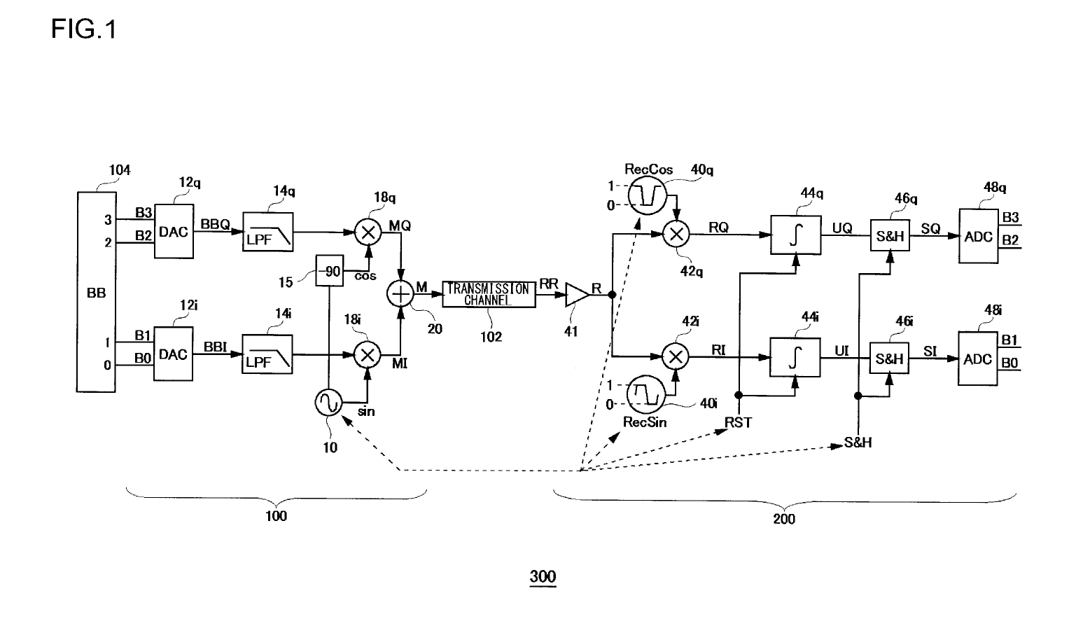

FIG. 1 is a circuit diagram illustrating the structure of a transmission system 300 using a quadrature amplitude demodulator 200 according to an embodiment. The transmission system 300 comprises a quadrature amplitude modulator 100, a transmission channel 102, a baseband data generator 104, and the demodulator 200. The quadrature amplitude modulator 100 generates a modulated signal M on which multi-level quadrature amplitude modulation such as 16-QAM, 64-QAM, 256-QAM and the like, is performed such that the modulated signal M is transmitted to the demodulator 200 via the transmission channel 102. Herein, it is generalized that the (2^{m})²-level quadrature amplitude modulation is performed. The transmission system 300 is, as an example, used for transmitting data between separate semiconductor devices. In this case, the baseband data generator 104 and the quadrature amplitude modulator 100 are mounted in a semiconductor device on the transmission side, and the demodulator 200 is in a semiconductor device on the reception side.

At first, the structure on the quadrature amplitude modulator 100 side will be described. The structure of the quadrature amplitude modulator 100 may be a typical one.

The baseband data generator 104 generates (2^{m}) -level in-phase baseband data and (2^{m})-level quadrature baseband data. In FIG. 1, the case of m=2 is exemplified in which a circuit executing 16-level QAM is illustrated. However, the present invention is also effective to other cases of m=3 (64-QAM) and m=4 (256-QAM), etc. The in-phase baseband data and the quadrature baseband data are outputted as m-bit binary data (B0, B1) and (B2, B3), respectively.

The quadrature amplitude modulator 100 receives the (2^{m})-level in-phase baseband data (B1, B0) and the (2^{m})-level quadrature baseband data (B3, B2), and generates a modulated signal Mon which (2^{m})²-level quadrature amplitude modulation is performed. The quadrature amplitude modulator 100 includes D/A converters 12i and 12q, low-pass filters 14i and 14q, an oscillator 10, a phase shifter 15, mixers 18i and 18q, and an adder 20.

The oscillator 10 generates an in-phase carrier signal RecSin having a sine wave. The phase shifter 15 shifts the phase of the in-phase carrier signal RecSin by 90° (¼ cycle) to generate a quadrature carrier signal RecCos.

The D/A converters 12i and 12q perform digital/analog conversion such that the baseband data (B1, B0) and (B3, B2) are converted into analog baseband signals BBI and BBQ, respectively.

The mixers 18i and 18q multiply the analog baseband signals BBI and BBQ by the corresponding carrier signals RecSin and RecCos, respectively. Namely, the mixer 18 amplitude modulates the carrier signal with the baseband signal being a modulated signal. Modulated signals MI and MQ are outputted from the mixers 18i and 18q, respectively. The adder 20 adds together the modulated signal MI on the I phase side and the modulated signal MQ on the Q phase side.

The structure of the modulator that generates the modulated signal M is not limited to that in FIG. 1, but, for example, a rectangular wave, a trapezoidal wave or a waveform similar to these may be used as a carrier signal.

Subsequently, the structure of the quadrature amplitude demodulator 200 according to an embodiment will be described. The demodulator 200 comprises an amplifier 41, oscillators 40i and 40q, mixers 42i and 42q, integrators 44i and 44q, sample-hold circuits 46i and 46q, and A/D converters 48i and 48q. The amplifier 41 amplifies the modulated signal RR that is propagated through the transmission channel 102. The amplifier 41 may be a mere amplifier or an equalizer that compensates attenuation by the transmission channel 102. When the attenuation of the received modulated signal PR and deterioration of the waveform thereof can be neglected, the amplifier 41 can be omitted.

The oscillator 40i generates the in-phase carrier signal RecSin having a rectangular wave, a trapezoidal wave or a waveform similar to these. The oscillator 40q generates the quadrature carrier signal RecCos, the phase of which is shifted by ¼ cycle relative to the in-phase carrier signal RecSin. The carrier signals RecSin and RecCos generated by the oscillators 40i and 40q are required to be synchronized with the carrier signal of the received modulated signal R. A general carrier reproduction technique has to be used for the synchronization of the carrier signal.

A first mixer 42i and a second mixer 42q respectively perform mixing of the modulated signal R from the amplifier 41 with the in-phase carrier signal RecSin and the quadrature carrier signal RecCos such that the mixed signals are down-converted into low-frequency signals.

A first integrator 44i and a second integrator 44q respectively integrate output signals RI and RQ of the first mixer 42i and the second mixer 42q for a predetermined integration period in accordance with the cycle of the in-phase carrier signal RecSin and the quadrature carrier signal RecCos.

The aforementioned predetermined period is set as follows.

1. When the frequency (carrier frequency) of the carrier signals RecSin and RecCos is equal to the symbol rate of the modulated signal R, the predetermined integration period is equal to one cycle of the carrier signal, in other words, a symbol cycle.

2. When the frequency of the carrier signals RecSin and RecCos is equal to n times the symbol rate of the modulated signal R, the predetermined integration period can be set to either one of the two stated below:
2.1 n cycles of the carrier signal, in other words, the symbol cycle; and
2.2 one cycle of the carrier signal. When the integration period is set to one cycle of the carrier signal (2.2), n times of integration results can be obtained across one symbol. The integrator 44 may output any one of the n integration results, or output data on which statistical processing such as averaging is performed.

Output values of the integrators 44i and 44q are reset at the timing of a reset signal RST asserted at every integration period.

A first sample-hold circuit 46i and a second sample-hold circuit 46q respectively sample and hold outputs UI and UQ of the first integrator 44i and the second integrator 44q at every boundary between the symbols that are adjacent to each other in terms of time, that is, at every symbol cycle. The sample-hold circuits 46i and 46q sample input signals at the timing of a sample-hold signal S&H asserted at every symbol cycle.

A first A/D converter 48i and a second A/D converter 48q respectively perform analog/digital conversion on output signals SI and SQ of the first sample-hold circuit 46i and the second sample-hold circuit 46q to generate the baseband signal (B1, B0) and (B3, B2).

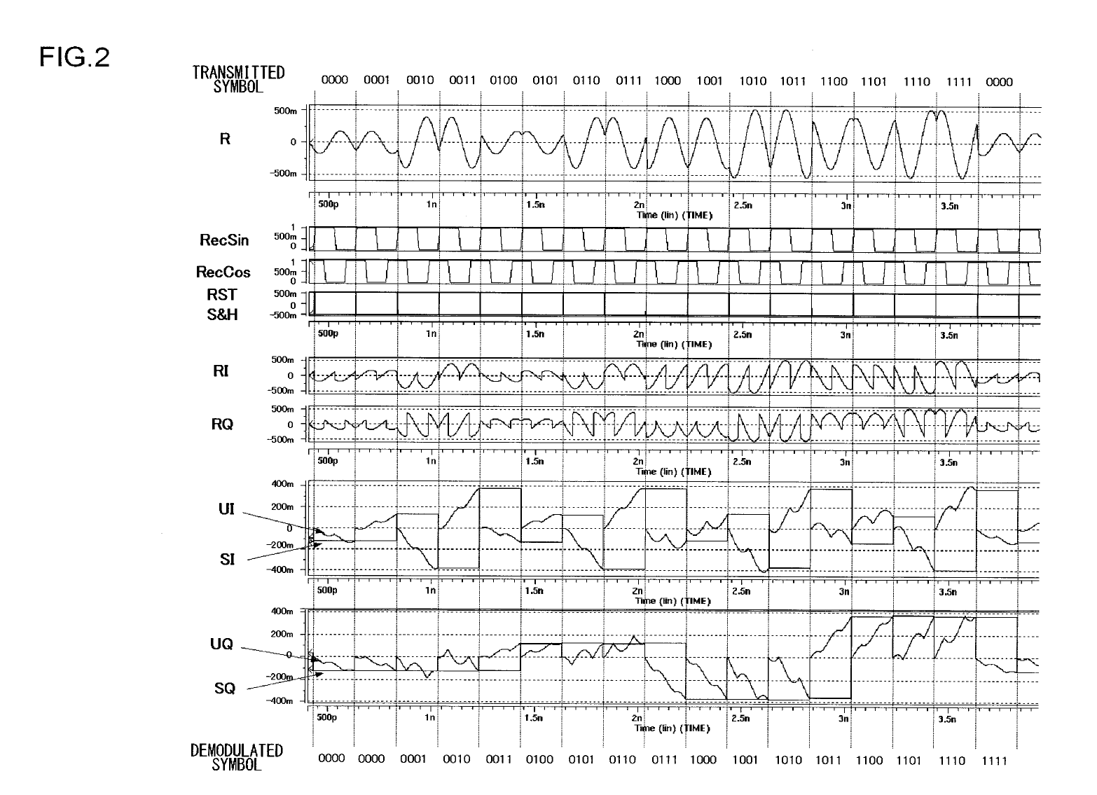

The structure of the quadrature amplitude demodulator 200 according to an embodiment has been described above. Subsequently, operation thereof will be described. FIG. 2 is a time chart illustrating operation of the quadrature amplitude demodulator 200. The modulated signal R illustrated in FIG. 2 is one that is generated by using the carrier signal having a sine wave (cosine wave) in the quadrature amplitude modulator 100, and that is received via the lossless transmission channel 102. Herein, the case where the symbol rate and the carrier frequency are equal to each other is illustrated.

Signals corresponding to the analog baseband signals BBI and BBQ on the transmission side can be extracted by performing down-conversion using the carrier signals RecSin and RecCos having rectangular waves, and by integrating the obtained signals for one cycle of the carrier signal. The baseband data (B1, B0) and (B3, B2) can be reproduced by performing analog/digital conversion on the extracted signals.

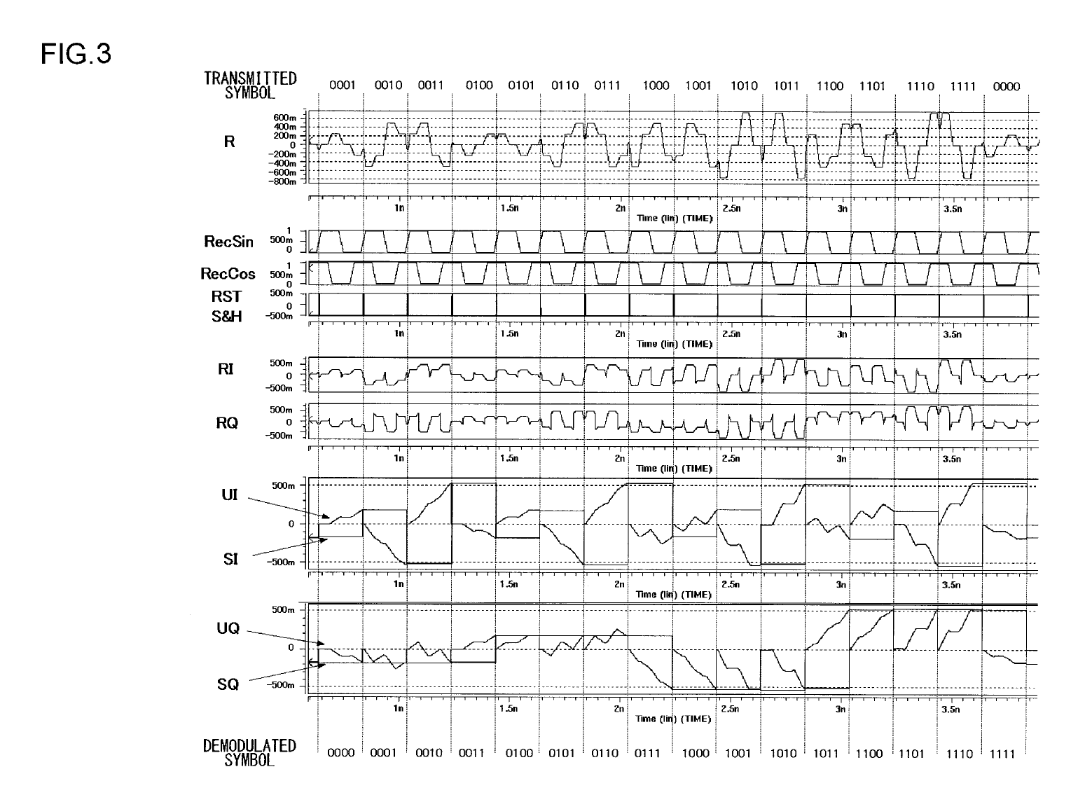

FIG. 3 is another time chart illustrating operation of the quadrature amplitude demodulator 200. The modulated signal R in FIG. 3 is one that is generated by using the carrier signal having a rectangular wave in the quadrature amplitude modulator 100, and that is received via the lossless transmission channel 102.

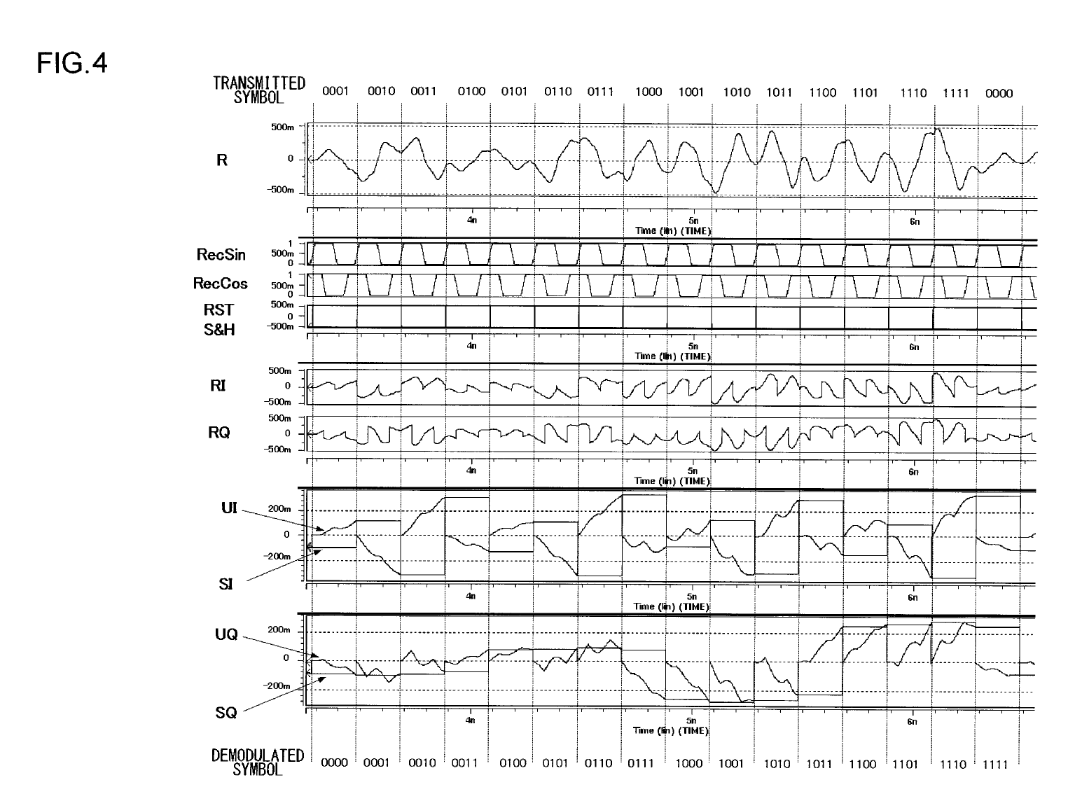

FIG. 4 is yet another time chart illustrating operation of the quadrature amplitude demodulator 200. The modulated signal R in FIG. 4 is one that is generated by using the carrier signal having a rectangular wave, in the quadrature amplitude modulator 100, and that is received via the 0.4-m long transmission channel 102 having a loss, which is formed on a printed circuit board.

The quadrature amplitude demodulator 200 in FIG. 1 can also demodulate the baseband signal with respect to the modulated signals R in FIGS. 3 and 4.

In the quadrature amplitude demodulator 200 in FIG. 1, a low-pass filter used in a conventional demodulator can be replaced by an integrator. In the case of the low-pass filter, there are many design issues to be considered such as a cut-off frequency and slope characteristic, etc., and a mounting area for the filter is large. In contrast, in the case of the integrator, there are advantages that design thereof is easy and a mounting area for the integrator can be reduced.

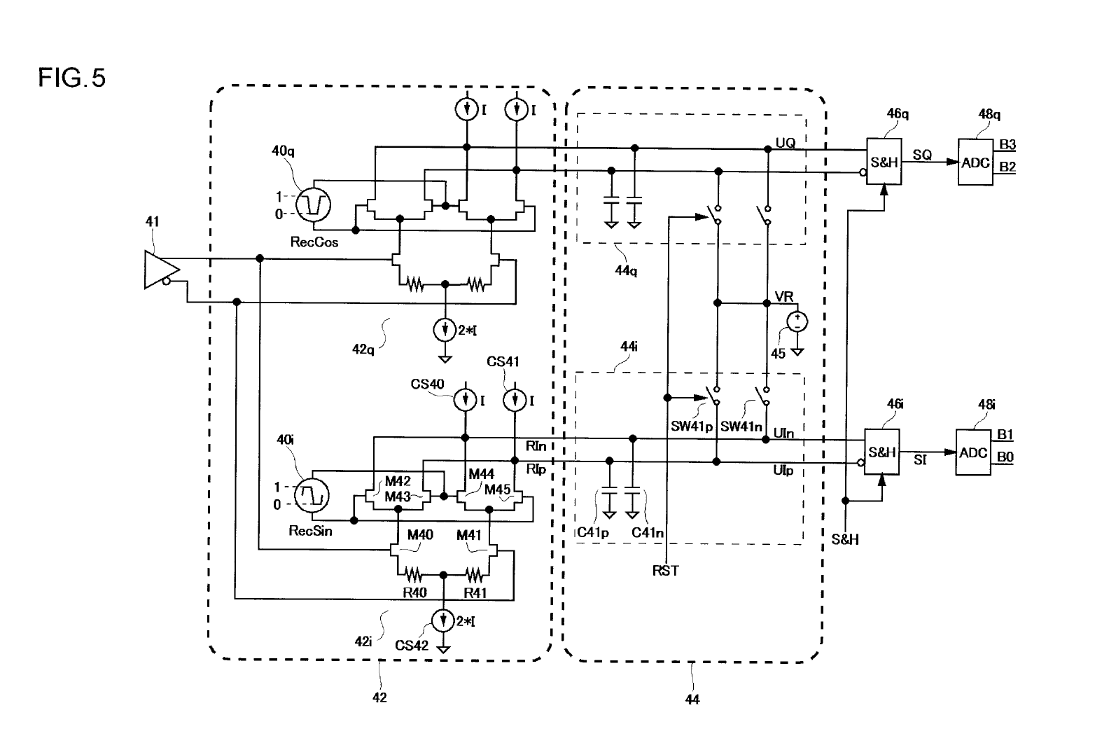

FIG. 5 is a circuit diagram illustrating specific examples of the mixer 42 and the integrator 44. The mixers 42i and 42q have the same structure with each other, and the integrators 44i and 44q have the same structures with each other. Accordingly, herein, only circuit blocks 42i and 44i that process the in-phase components will be described.

The modulated signal R outputted from the amplifier 41 is a differential signal. The first mixer 42i is a Gilbert Cell mixer configured to perform mixing of the modulated signal R with the corresponding carrier signal RecSin. Specifically, the mixer 42i comprises transistors M40 through M45, current sources CS40 through CS42, and resistors R40 and R41. The transistors M40 through M45 may be bipolar transistors instead of MOSFETs. There is a feature that a load circuit for the Gilbert cell mixer is the current sources CS40 and CS41. The mixed signal is outputted to the integrator 44i in the subsequent stage as a differential current signal.

The integrator 44i includes first capacitors C41p and C41n and first switches SW41p and SW41n. The first capacitors C41p and C41n are respectively provided between lines through which differential output signals RIp and RIn of the mixer 42i are propagated, and fixed voltage terminals (ground terminals). One end of each of the first switches SW41p and SW41n is applied with an initialization voltage VR generated by a voltage source 45. The first switches SW41p and SW41n are respectively turned on at every boundary between the symbols by synchronizing with the reset signal RST such that electric charges of the first capacitors C41p and C41n are initialized. The initialization voltage VR may be a common voltage of the differential signals Rip and RIn.

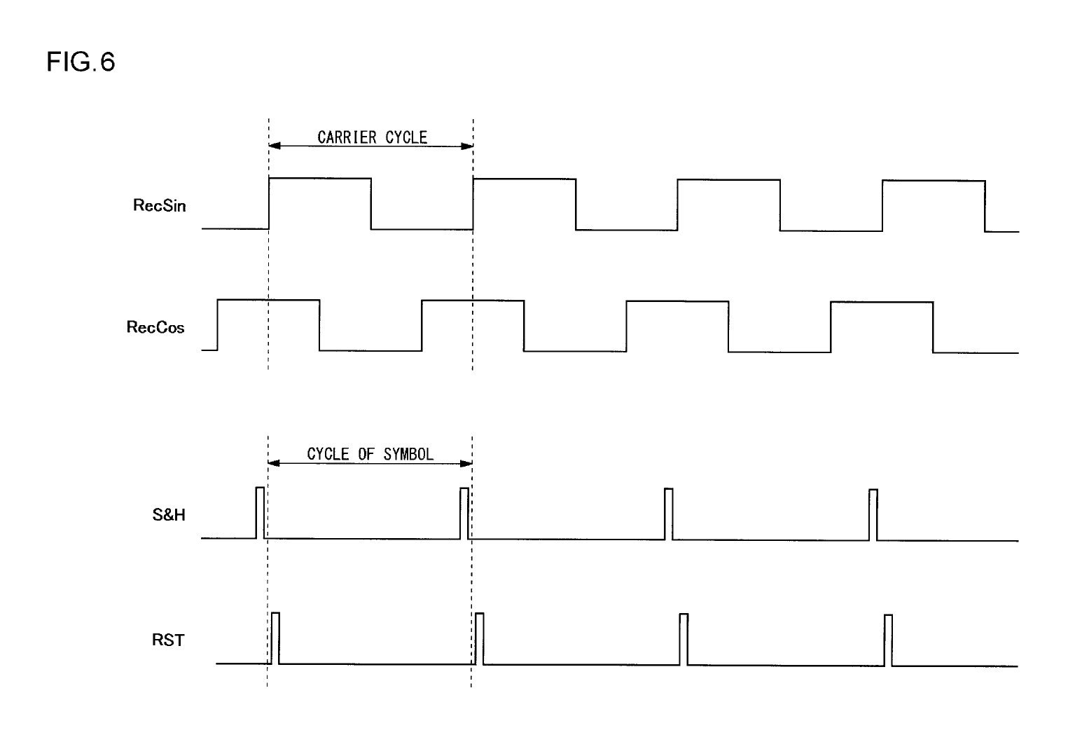

FIG. 6 is a time chart illustrating the reset signal RST and the sample-hold signal S&H. The reset signal RST is asserted immediately after the start of the carrier cycle such that the first switches SW41p and SW41n are turned on and the electric charges of the first capacitors C41p C41n are initialized. Thereafter, the first capacitors C41p and C41n are charged or discharged by an output current of the mixer 42i, and an output of the mixer 42i is integrated. The sample hold signal S&H is asserted immediately before the end of the carrier cycle such that electric potentials UIp and UIn of the first capacitors C41p and C41n are sampled. Each of the sampled differential electric potentials UIp and UIn is outputted as a single-end signal SI.

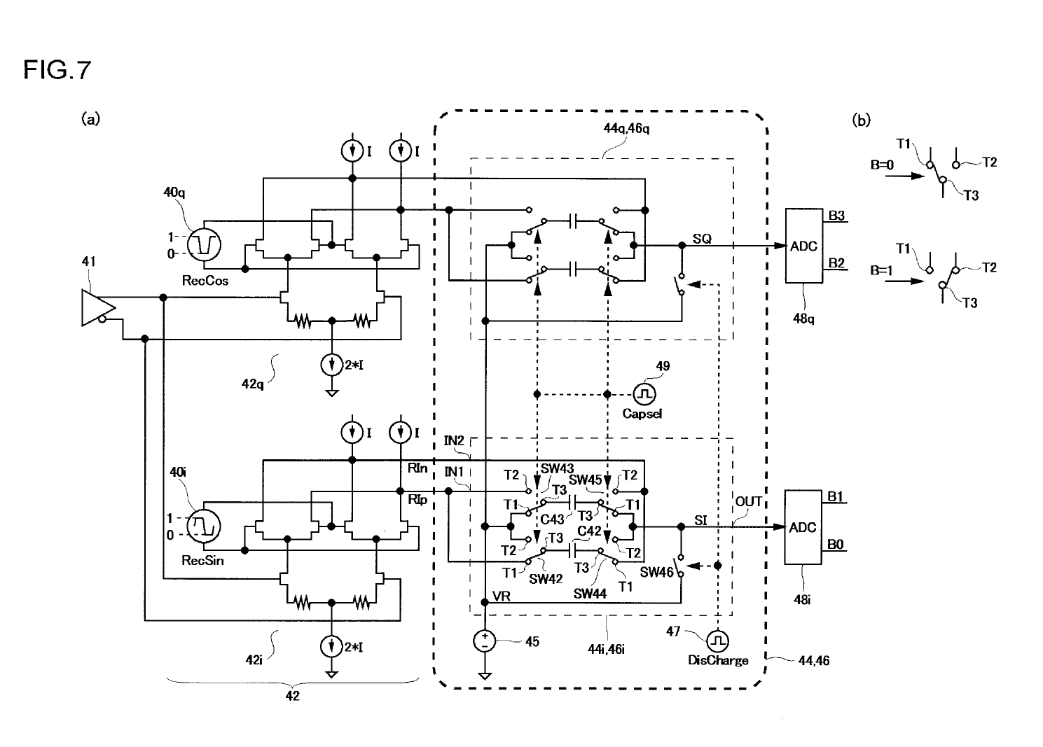

FIGS. 7A and 7B are circuit diagrams illustrating specific examples of the structures of the integrator 44 and the sample-hold circuit 46. In the structure in FIG. 7A, the integrator 44 and the sample-hold circuit 46 are integrally structured. The structure of the mixer 42 is the same as in FIG. 5, which outputs the differential current signals RIp and RIn.

The pair of the first integrator 44i and the first sample-hold circuit 46i, and the pair of the second integrator 44q and the second sample-hold circuit 46q, are structured in the same way with each other. The pair of the first integrator 44i and the first sample-hold circuit 46i includes a first input terminal IN1, a second input terminal IN2, an output terminal OUT, a second capacitor C42, a third capacitor C43 and a second switch SW42 through a sixth switch SW46. The first polarity signal RIp of the differential output signals of the mixer 42i is inputted to the first input terminal IN1. The second polarity signal RIn thereof is inputted to the second input terminal IN2.

Each of the second switch SW42 through the fifth switch SW45 comprises first, second and third terminals T1 to T3. The first terminal T1 of the second switch SW42 is connected to the first input terminal IN1. A predetermined reset voltage VR is inputted to the second terminal T2 thereof. The third terminal T3 thereof is connected to one end of the second capacitor C42. The second terminal of the third switch SW43 is connected to the first input terminal IN1. The reset voltage VR is inputted to the first terminal thereof, and the third terminal thereof is connected to one end of the third capacitor C43.

The second terminal of the fourth switch SW44 is connected to the output terminal OUT, and the first terminal thereof is connected to the second input terminal IN2, and the third terminal thereof is connected to the other end of the second capacitor C42. The first terminal of the fifth switch SW45 is connected to the output terminal OUT, and the second terminal thereof is connected to the second input terminal IN2, and the third terminal thereof is connected to the other end of the third capacitor C43. One end of the sixth switch SW46 is connected to the output terminal OUT, and the other end thereof is applied with the reset voltage VR.

The second switch SW42 through the fifth switch SW45 respectively place alternately a first state where the first terminal T1 and the third terminal T3 conduct electricity to each other, and a second state where the second terminal T2 and the third terminal T3 conduct electricity to each other, at every boundary between the symbols that are adjacent to each other in terms of time, in accordance with a capacitor selection signal CapSel generated by a capacitor control unit 49.

The sixth switch SW46 is turned on for a predetermined discharge period while a discharge control signal DisCharge generated by a discharge control unit 47 is being asserted, prior to the time when the symbols are switched. When the sixth switch SW46 is turned on, either one of the electric charges of the second capacitor C42 and the third capacitor C43 is initialized.

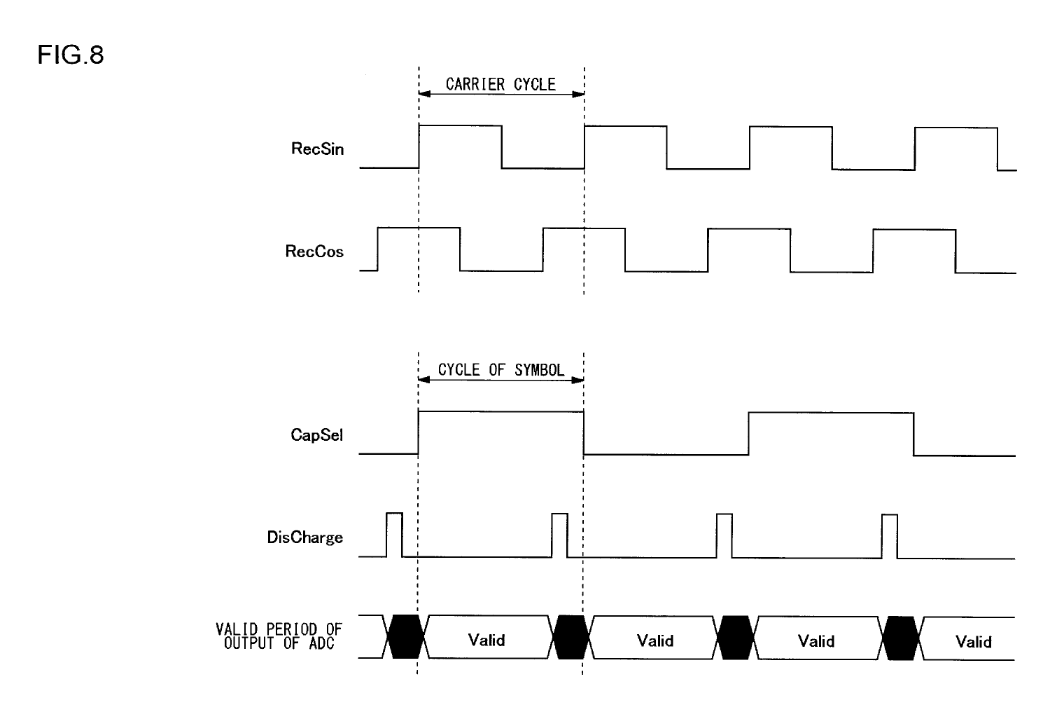

FIG. 8 is a time chart illustrating operations of the integrator 44i and the sample-hold circuit 46i in FIG. 7. The output signal (B1, B0) of the A/D converter 48i is valid for the period represented by “Valid” in the drawing, i.e., for the period between the transition of the capacitor selection signal CapSel and the timing when the discharge control signal DisCharge is asserted.

According to the structure in FIG. 7, the sample-hold circuit and the integrator can be integrally formed as the structure in FIG. 1, allowing a circuit area to be reduced.

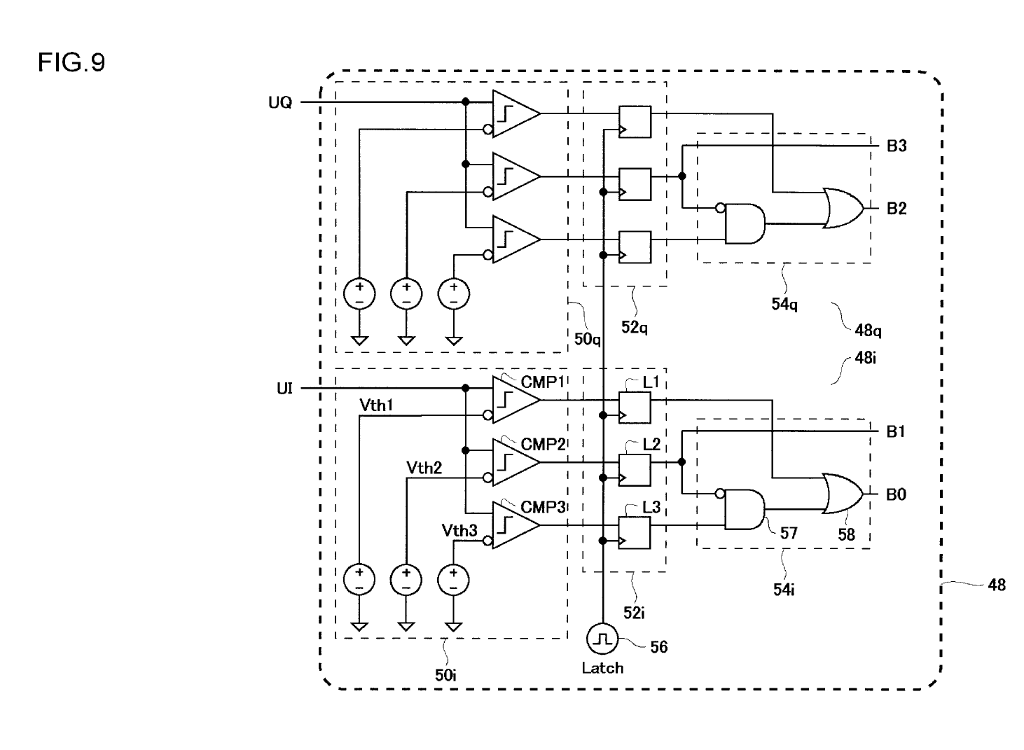

FIG. 9 is a circuit diagram illustrating a specific example of the structure of the A/D converter 48. The A/D converters 48i and 48q are structured in the same way with each other.

The first A/D converter 48i includes a comparison unit 50i, a latch unit 52i and an encoder 54i. The comparison unit 50i includes a plurality of comparators CMP1 to CMP3 such that each of the comparators CMP1 to CMP3 compares an output signal of the integrator 44i with each of the threshold voltages Vth1 to Vth3 set for the respective comparators. The latch unit 52i is provided for each of the comparators CMP1 to CMP3, and includes latch circuits L1 to L3 configured to respectively latch outputs of the corresponding comparators. Each of the latch circuits L1 to L3 latches the corresponding data at the positive edge timing of a latch signal Latch generated by a latch control unit 56. The latch signal Latch is asserted every time when the symbols are switched.

The encoder 54i receives output signals of the plurality of comparators CMP1 to CMP3 latched by the latch unit 52i, and encodes the signals into a format optimal for the processing in the subsequent stage. Because the outputs of the comparators CMP1 to CMP3 are so-called thermometer codes, the encoder in FIG. 9 converts the output signal into binary data. Specifically, the encoder 54i includes an AND gate 57 and an OR gate 58.

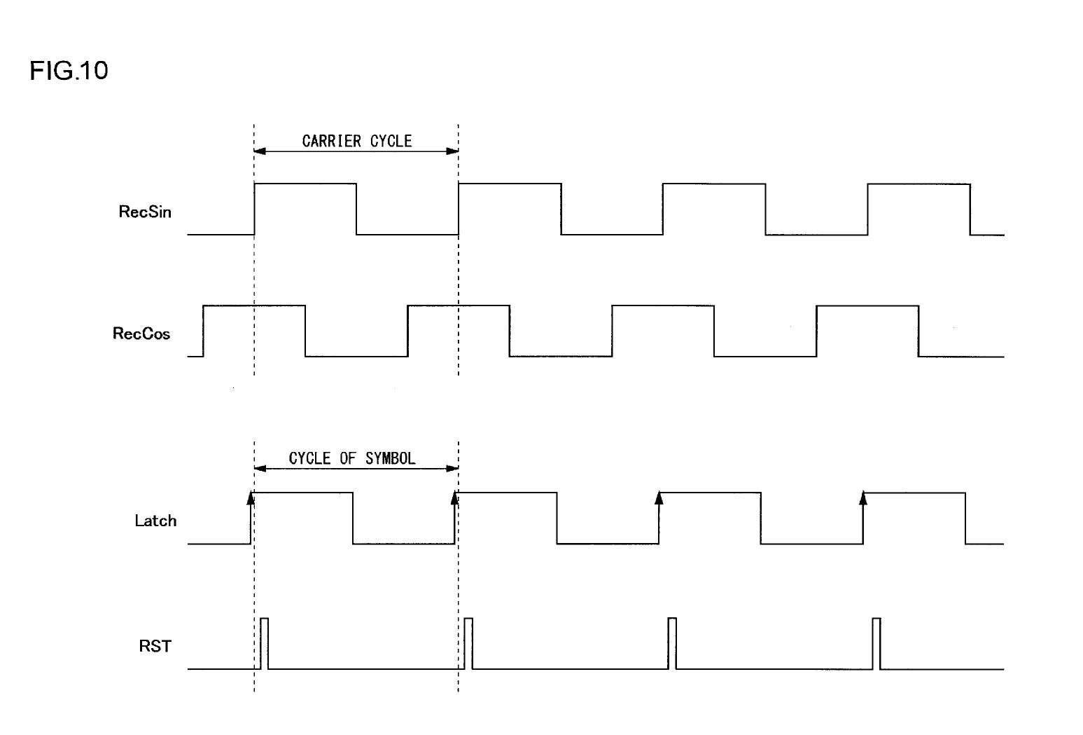

FIG. 10 is a time chart illustrating operation of the A/D converter 48 in FIG. 9. Because the latch signal Latch is asserted at every symbol cycle, the binary data B1 and B0, which are finally generated, become valid for one symbol cycle. That is, when using the A/D converter 48 in FIG. 9, the sample-hold circuit becomes unnecessary in the preceding stage, allowing a circuit area to be reduced.

In the structure in FIG. 9, the latch unit 52i is arranged in the subsequent stage of the comparison unit 50i; however, the structure may be possible in which the latch unit is arranged in the subsequent stage of the encoder 54i to latch the binary data B1 and B0, which are finally generated.

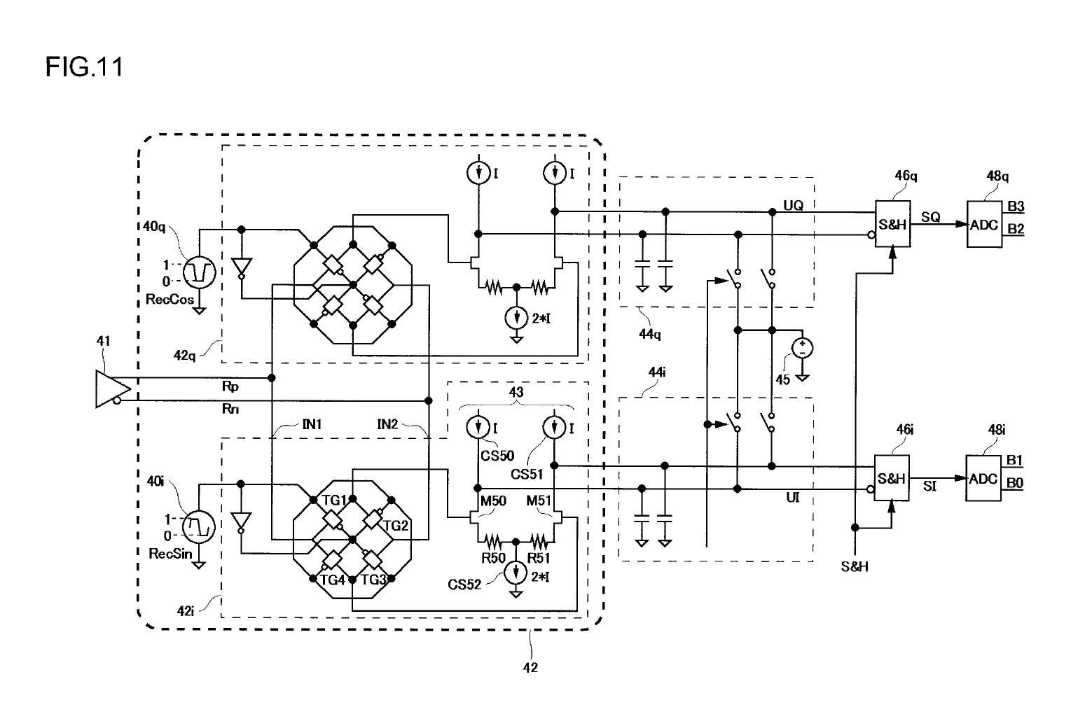

FIG. 11 is a circuit diagram illustrating another example of the structure of the mixer 42. Other parts of the structure are the same as in FIG. 5. Differential modulated signals Rp/Rn are inputted to the mixer 42i.

The first polarity signal Rp and the second polarity signal Rn of the modulated signal R are respectively inputted to the first and the second input terminals IN1 and IN2. A first gate TG1 and a second gate TG2 are provided in series between the first input terminal IN1 and the second input terminal IN2. A third gate TG3 and a fourth gate TG4 are provided between the first input terminal IN1 and the second input terminal IN2, and provided in parallel with the pathway formed by the first and the second gates TG1 and TG2. A transfer gate and an analog switch can be preferably used for the first gate TG1 through the fourth gate TG4.

The pair of the first gate TG1 and the third gate TG3 and the pair of the second gate TG2 and the fourth gate TG4, complementarily repeat ON/OFF in accordance with the corresponding carrier signal RecSin.

The differential amplifier 43 differentially amplifies an electric potential at the connection point between the first gate TG1 and the second gate TG2, and an electric potential at the connection point between the third gate TG3 and the fourth gate TG4. The differential amplifier 43 includes transistors M50 and M51 configured to form a pair of differential inputs, current sources CS50 and CS51 configured to be provided as loads for the pair of differential inputs, resistors R50 and R51 configured to be provided on the source side of the transistors M50 and M51, and a tail current source CS52. Differential outputs of the differential amplifier 43 are outputted to the integrator 44i in the subsequent stage.

According to the mixer 42 in FIG. 11, the number of stages of the transistors that are vertically piled up between a power supply voltage and the ground is reduced in comparison with the Gilbert Cell mixer in FIG. 5, and hence the mixer 42 is suitable for the operation at a low power supply voltage.

Subsequently, a preferred application of the quadrature amplitude demodulator 200 according to an embodiment will be described. As described below, the quadrature amplitude demodulator 200 can be used in a test apparatus for testing a semiconductor device capable of transmitting a 16-QAM signal, as well as being mounted in a reception unit of a semiconductor device.

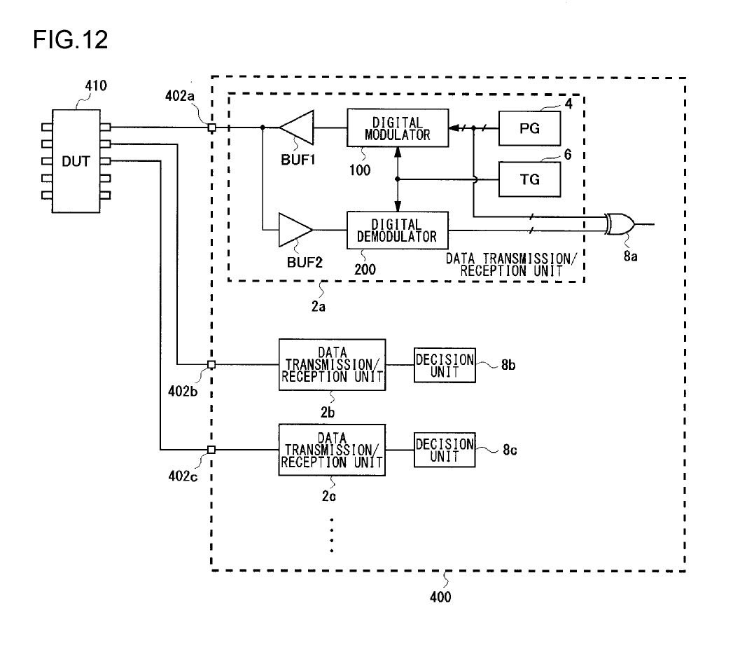

FIG. 12 is a block diagram illustrating the structure of a test apparatus 400 in which the quadrature amplitude demodulator 200 according to an embodiment is mounted. The test apparatus 400 comprises a plurality of I/O terminals 402a, 402b and 402c, . . . configured to be provided for every I/O port of a DUT. The number of the I/O ports is arbitrary; however, in the case of a memory or an MPU, tens to more than 100 I/O ports are provided. Each of the plurality of I/O terminals 402 is connected to the corresponding I/O port of the DUT 410 via a transmission line.

The test apparatus 400 comprises a plurality of data transmission/reception units 2a, 2b and 2c . . . , and decision units 8a, 8b and 8c . . . , each of which is provided for each of the plurality of I/O terminals 402a, 402b and 402c, . . . . Because the plurality of data transmission/reception units 2 and the decision units 8 respectively have the same structures with each other, only the structures of the data transmission/reception unit 2a and the decision unit 8a will be illustrated in detail.

Each data transmission/reception unit 2 comprises: (1) a function of modulating a carrier signal (carrier wave) having a rectangular wave or a trapezoidal wave into a multi-level QAM signal, with pattern data (baseband data) to be supplied to the DUT 410 being a modulating signal, so that the multi-level QAM signal is outputted to the corresponding I/O port of the DUT 410; and (2) a function of receiving the modulated signal outputted from the DUT 410 and demodulating the signal. The demodulated data is compared with an expected value to determine pass/fail of the DUT 410.

The data transmission/reception unit 2 comprises a pattern generator 4, a timing generator 6, an output buffer BUF1, an input buffer BUF2, a digital modulator 100 and a digital demodulator 200.

The pattern generator 4 generates a test pattern to be supplied to the DUT 410. Each data (also referred to as pattern data) of the test pattern has the number of bits in accordance with a format for digital modulation/demodulation used for transmitting data between the DUT 410 and the test apparatus 400. For example, in the case of 16-QAM, each data has 4 bits; and in the case of 64-QAM, each data has 6 bits.

The timing generator 6 generates a timing signal and outputs the signal to the digital modulator 100. The timing generator 6 can adjust the phase of the timing signal finely, for example, in the order of several ps to several ns, for every cycle of the pattern data. The timing generator 6 and the pattern generator 4 can use known circuits used in a test apparatus for a system in which a conventional binary transmission is performed.

The digital modulator 100 generates a modulated signal on which quadrature amplitude modulation (for example, 16-QAM) is performed in accordance with the pattern data such that the modulated signal is outputted as a test signal. The test signal is outputted to the DUT 410 by the output buffer BUF1.

The input buffer BUF2 receives a signal to be tested, which is outputted from the DUT 410, and outputs the signal to the digital demodulator 200. The digital demodulator 200 demodulates the modulated signal to extract digital data. The digital demodulator 200 is structured by the architecture of the quadrature amplitude demodulator 200 stated above. The decision unit 8a compares the data demodulated by the digital demodulator 200 with an expected vale outputted from the pattern generator 4. The output buffer BUF1 and the input buffer BUF2 may be structured as a bidirectional buffer.

The structure of the test apparatus 400 has been described above. According to the test apparatus 400, a multi-level QAM signal can be demodulated based on a logic circuit, and hence, design of the test apparatus becomes easy and the test apparatus can be produced at a reduced cost.

The present invention has been described based on the embodiments, which is only intended to illustrate the principle and applications of the invention, and a variety of modifications and variations in arrangement may be made to the embodiments within the range not departing from the spirit of the invention specified in appended claims.

1. A quadrature amplitude demodulator that demodulates a modulated signal on which quadrature amplitude modulation is performed, the quadrature amplitude demodulator comprising:
an oscillator configured to generate an in-phase carrier signal having a rectangular wave, a trapezoidal wave or a waveform similar to these, and a quadrature carrier signal, the phase of which is shifted by ¼ cycle relative to the in-phase carrier signal;
first and second mixers configured to respectively perform mixing of the modulated signal with the in-phase carrier signal and the quadrature carrier signal;
first and second integrators configured to respectively integrate output signals of the first and the second mixers for a predetermined period in accordance with the cycle of the in-phase carrier signal and the quadrature carrier signal; and
first and second A/D converters configured to respectively convert outputs of the first and the second integrators into digital values.

2. The quadrature amplitude demodulator according to claim 1 further comprising first and second sample-hold circuits configured to respectively sample and hold the output signals of the first and the second integrator at every boundary between symbols that are adjacent to each other in terms of time, wherein the first and the second A/D converters respectively convert output signals of the first and the second sample-hold circuits into digital values.

3. The quadrature amplitude demodulator according to claim 1, wherein the modulated signal, the in-phase carrier signal and the quadrature carrier signal are respectively differential signals, and wherein the first and the second mixers are respectively Gilbert Cell mixers configured to perform the mixing of the modulated signal with the corresponding carrier signals.

4. The quadrature amplitude demodulator according to claim 1, wherein each of the first and the second integrators includes:
a first capacitor configured to be provided between a line through which each of the output signals of the first and the second mixers is propagated, and a fixed voltage terminal; and
a first switch configured to initialize an electric charge of the first capacitor at every boundary between the symbols adjacent to each other in terms of time.

5. The quadrature amplitude demodulator according to claim 2, wherein the respective output signals of the first and the second mixers are differential signals, and wherein each of a pair of the first integrator and the first sample-hold circuit and a pair of the second integrator and the second sample-hold circuit includes;
a first input terminal configured to receive a first polarity signal of differential output signals of the corresponding mixer;
a second input terminal configured to receive a second polarity signal of the differential output signals of the corresponding mixer;
an output terminal;
a second capacitor;
a third capacitor;
a second switch configured to include first, second and third terminals, the first terminal of which is connected to the first input terminal, and the second terminal of which receives a predetermined fixed voltage, and the third terminal of which is connected to one end of the second capacitor;
a third switch configured to include first, second and third terminals, the second terminal of which is connected to the first input terminal, and the first terminal of which receives a predetermined fixed voltage, and the third terminal of which is connected to one end of the third capacitor;
a fourth switch configured to include first, second and third terminals, the second terminal of which is connected to the output terminal, and the first terminal of which is connected to the second input terminal, and the third terminal of which is connected to the other end of the second capacitor;
a fifth switch configured to include first, second and third terminals, the first terminal of which is connected to the output terminal, and the second terminal of which is connected to the second input terminal, and the third terminal of which is connected to the other end of the third capacitors; and
a sixth switch, one end of which is connected to the output terminal, and the other end of which is applied with a fixed voltage, and
wherein the second through the fifth switches respectively place alternately a first state where the first terminal and the third terminal conduct electricity to each other, and a second state where the second terminal and the third terminal conduct electricity to each other, at every boundary between the symbols that are adjacent to each other in terms of time, and wherein the sixth switch is turned on for a predetermined period prior to the time when the symbols are switched.

6. The quadrature amplitude demodulator according to claim 1, wherein each of the first and the second A/D converters includes:
a plurality of comparators configured to respectively compare output signals of the corresponding integrators with threshold voltages set for each comparator;
an encoder configured to receive output signals of the plurality of comparators to encode the output signals; and
a latch circuit configured to latch the outputs of the plurality of comparators or an output of the encoder, or both of the two.

7. The quadrature amplitude demodulator according to claim 1, wherein each of the first and the second mixers includes:
a first input terminal configured to receive the first polarity signal of the differential modulated signals;
a second input terminal configured to receive the second polarity signal of the differential modulated signals;
first and second gates configured to be provided in series between the first and the second input terminals; third and fourth gates configured to be provided in series between the first and the second input terminals, and provided in parallel with a pathway formed by the first and the second gates; and
a differential amplifier configured to differentially amplify an electric potential at the connection point of the first and the second gates, and that at the connection point of the third and the fourth gates, and
wherein a pair of the first and the third gates and a pair of the second and the fourth gates, complementarily repeat on and off in accordance with the corresponding carrier signals.

8. The quadrature amplitude demodulator according to claim 1, wherein, when the frequency of the in-phase carrier signal and the quadrature carrier signal is equal to a symbol rate of the modulated signal, the first and the second integrators respectively integrate the output signals of the first and the second mixers, for one cycle of the carrier signal.

9. The quadrature amplitude demodulator according to claim 1, wherein, when the frequency of the in-phase carrier signal and the quadrature carrier signal is n times larger than the symbol rate of the modulated signal, the first and the second integrators respectively integrate the output signals of the first and the second mixers, for n cycles of the carrier signal.

10. A test apparatus for testing a quadrature amplitude modulated signal outputted from a device under test, the test apparatus comprising:
the quadrature amplitude demodulator according to claim 1 configured to demodulate the signal; and
a decision unit configured to compare data demodulated by the quadrature amplitude demodulator with an expected value.

11. A semiconductor apparatus comprising the quadrature amplitude demodulator according to claim 1.

12. A method for demodulating a modulated signal on which quadrature amplitude modulation is performed, the method comprising:
generating an in-phase carrier signal having a rectangular wave, a trapezoidal wave or a waveform similar to these, and a quadrature carrier signal, the phase of which is shifted by ¼ cycle relative to the in-phase carrier signal;
performing mixing of the modulated signal with the in-phase carrier signal and the quadrature carrier signal, respectively;
integrating an in-phase component and a quadrature component that are obtained by the mixing, for a predetermined period in accordance with the cycle of the in-phase carrier signal and the quadrature carrier signal, respectively; and
converting the in-phase component and the quadrature component that are obtained by the integrating into digital values, respectively.
